(19) United States
(12) Patent Application Publication
(10) Pub. No.: US 2017/0068904 A1
(43) Pub. Date: Mar. 9, 2017

(54) Determining the Destination of a Communication

(71) Applicant: Microsoft Technology Licensing, LLC, Redmond, WA (US)

(72) Inventors: Jacek A. Korycki, San Jose, CA (US); David L. Racz, Palo Alto, CA (US)

(21) Appl. No.: 14/849,267

(22) Filed: Sep. 9, 2015

(51) Int. Cl. G06N 99/00; H04L 12/58

(52) U.S. Cl. CPC G06N 99/005; H04L 51/28; H04L 51/32; H04L 51/04

(57) ABSTRACT

Training data is collected describing multiple past messages sent over a computer-implemented communication service. For each of the past messages, the training data set comprises a record of a respective channel of the respective message, and a record of respective feature vector of the respective message, wherein the channel corresponds to a respective one or more recipients to which the respective message was sent, and wherein the feature vector comprises a respective set of values of a plurality of parameters associated with the sending of the respective message. The training data is used to train a machine learning algorithm. By applying the machine learning algorithm to the feature vector of a respective subsequent message, to be sent by a sending user over the computer-implemented communication service, a prediction is generated regarding one or more potential recipients of the subsequent message.

### BACKGROUND

Document or message classification is known and has many uses. For example, in the news industry, document classification is a known problem where a new document is supposed to be assigned to one of the fixed categories, such as “domestic”, “international”, “about China”, “sports” etc. In some cases, such classification is assisted based on machine learning techniques, such as Naïve Bayes classifiers.

In email, automatic spam detection and filtering is used based on binary document classification of an email as spam or not spam. Naïve Bayes is a typical algorithm for this application as well.

### SUMMARY

However, it has not previously been considered that an automated approach could be taken to predicting the destination of a message (also referred to herein as a “channel”). For instance, the above approaches do not capture the richness of context in group communication systems, which include factors such as temporal dynamics (various topics discussed in the same channel over time), and social dynamics (the changing audience of the messages). Such areas are exploited herein, by selecting the proper features to represent these factors, and by defining a complementary training procedure. The output of the process may then suggest ways to utilize the results of classification to enhance the user experience, or may provide an alert of a possible mistake in directing the message to a selected channel.

According to one aspect disclosed herein, there is provided a method comprising collecting a training data set describing multiple past messages previously sent over a computer-implemented communication service. For each respective one of the past messages, the training data set comprises a record of a respective channel of the respective message, and a record of respective feature vector of the respective message, wherein the channel corresponds to a respective one or more recipients to which the respective message was sent, and wherein the feature vector comprises a respective set of values of a plurality of parameters associated with the sending of the respective message. The method further comprises inputting the training data into a machine learning algorithm in order to train the machine learning algorithm. By applying the machine learning algorithm to a further feature vector comprising a respective set of values of said parameters for a respective subsequent message, to be sent by a sending user over the computer-implemented communication service, the method then comprises generating a prediction regarding one or more potential recipients of the subsequent message.

A “channel” is a term used herein to refer to any definition directly or indirectly mapping to one or more recipients, e.g. an individual name or address of one or more recipients, or a group such as a chat room or forum used by the recipients, or a tag to which the recipients subscribe.

The parameters of each of the feature vectors may comprise one or more parameters based on the content of the respective message (i.e. the material in the payload of the message composed by the sending user), such as: a title of the respective message, one or more keywords in the respective message, and/or a measure of similarity between the respective message and one or more earlier messages in the training data set sent to the respective channel (by the sending user or by all users sending to the respective channel). Alternatively or additionally, the parameters may comprise other examples such as: an identifier of the sending user, a time of sending the respective message, an amount of previous activity of the sending user on the respective channel, and/or a relationship between the sending user and the respective one or more recipients (such as a social media connection).

Thus the present disclosure addresses the issue of accurately directing messages to channels in communication systems such as IM (instant messaging) chat systems, video messaging systems or email systems. The disclosure provides a machine learned classification method that can automatically learn based on existing history data in the system and be used at prediction time to compute probability of assigning a new message to one or more messaging channels. This information may be used to provide suggestions to the author about where (or where else) he/she should target the message after it has been composed. Alternatively, the predicted probability information may be used to compare against the target channel choices made by the author, and if sufficiently different, the may be used to prevent a mistake by alerting the author prior to sending the message, and giving him/her a chance to withdraw the message thus saving himself/herself undesirable consequences such as embarrassment, confusion of others, or leakage of sensitive information.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted in the Background section.

### BRIEF DESCRIPTION OF THE DRAWINGS

To assist understanding of the present disclosure and to show how embodiments may be put into effect, reference is made by way of example to the accompanying drawings in which:

FIG. 1 is a schematic block diagram of a communication system,

FIG. 2 is a schematic block diagram of a user terminal and server, and

FIG. 3 is a schematic illustration of a user interface.

### DETAILED DESCRIPTION

The following describes a scheme employing machine learned classification in order to enhance routing of newly composed messages to receiving users in text and document communication and collaboration systems (where “routing” herein refers to determining the destination of the message). IM chat messaging is one prominent example of such systems. In embodiments the destination may be defined in terms of an individual name or address of one or more recipient users, but alternatively the following also encompasses chat-room based messaging or the like, where the destination is defined as a particular chat room, forum or other group; or tag based messaging, wherein the destination is defined by one or more tags assigned by the author. Accordingly the concept of message destination is generalized herein as a “channel”.

In embodiments, the output of the machine learning is used to enhance the existing routing assigned “manually” by an author, as a list of channels, with one computed automatically by the system. This can help prevent mistakes when a message is about to be sent to a wrong or inappropriate place. In further embodiments, the output of the machine learning may be used to generate suggestions as to where the message might also be sent, or event to make fully automated routing without user specification or approval.

The following also specifies techniques for actually deriving such automated routing (list of recommended channels). In embodiments this is performed by defining a machine learning binary classification approach. This approach yields a prediction function that computes a probability value for each candidate channel. The most probable channels can then be compared with the channels selected by the user “by hand”, and act when the two lists diverge.

Furthermore, in embodiments the process may comprise the following components:
a scheme for defining a large training set of examples from existing data (history of communication) recorded by the communication system;
a scheme for defining a comprehensive set of features that describe quantitatively the full information context of the routing decision, including the message itself, the history of prior messages per channel, the author, the audience and time of posting; and
a scheme for accurate representation of the relationship of the new message to the history of prior messages in the channel that include the temporal dynamics, i.e. by combining similarities between the message and multiple various fragments of the history spread across time.

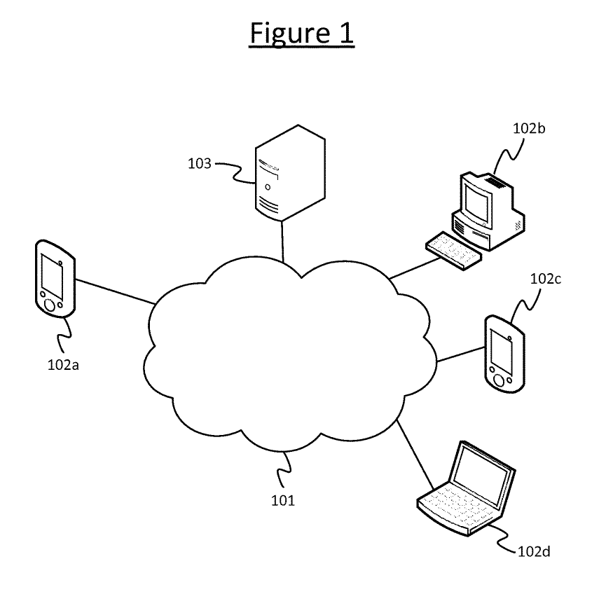

Some example implementations will now be discussed in more detail with reference to FIGS. 1 to 3.

FIG. 1 shows an example of a communication system in accordance with embodiments of the present disclosure. The system comprises a network 101, preferably a wide area internetwork such as the Internet; and a plurality of user terminals 102a-d each connected to the network 101 by a respective wired or wireless connection; and a optionally a server 103 also connected to the network 101. The following may be described in terms of the network 101 being the Internet, but it will be appreciated this is not necessarily limiting to all possible embodiments, e.g. alternatively or additionally the network 101 may comprise a company intranet or mobile a cellular network.

Each of the user terminals 102 may take any suitable form such as a smartphone, tablet, laptop or desktop computer (and the different user terminals 102 need not necessarily be the same type). Each of at least some of the user terminals 102a-d is installed with a respective instance of a communication client application. For example, the application may be an IM chat client by which the respective users of two or more of the user terminals can exchange textual message over the Internet, or the application may be a video messaging application by which the respective users of two or more of the terminals 102a-d can establish a video messaging session between them over the Internet 101, and via said session exchange short video clips in a similar manner to the way users exchange typed textual messages in an IM chat session (and in embodiments the video messaging session also enables the users to include typed messages as in IM chat). As another example, the client application may be an email client. The following may be described in terms of an IM chat session or the like, but it will be appreciated this is not necessarily limiting.

In embodiments, the messages referred to herein may be sent between user terminals 102 via a server 103, operated by a provider of the messaging service, typically also being a provider of the communication client application. Alternatively however, the message may be sent directly over the Internet 101 without travelling via any server, based on peer-to-peer (P2P) techniques. The following may be described in terms of a server based implementation, but it will be appreciated this is not necessarily limiting to all embodiments. Note also that where a server is involved, this refers to a logical entity being implemented on one or more physical server units at one or more geographical sites.

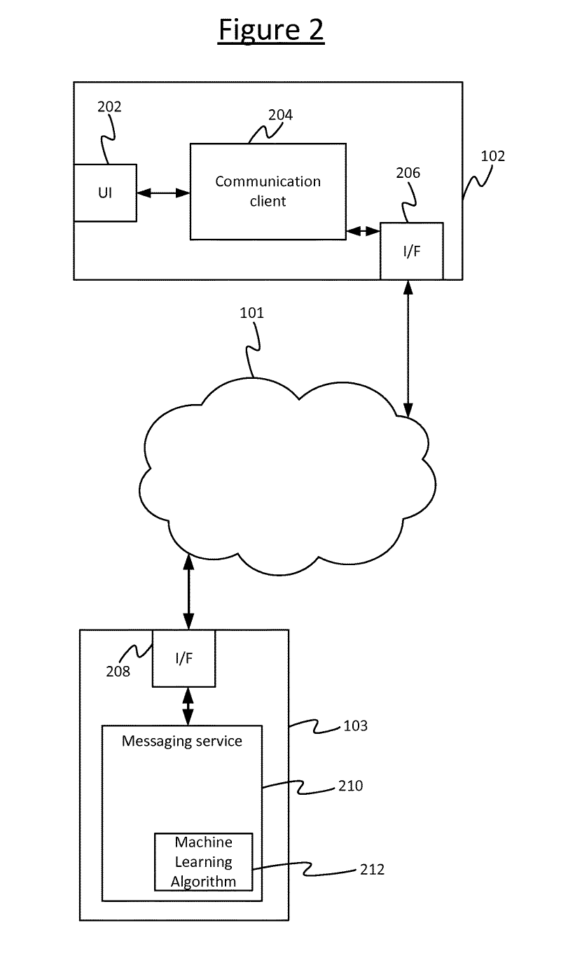

FIG. 2 shows a user terminal 102 in accordance with embodiments. At least a first of the user terminals 102a is configured in accordance with FIG. 2, and in embodiments one or more others 102b-d may also be configured this way. For purpose of illustration the following will be described in terms of the first user terminal 102a being a sending (near-end) user terminal sending a message to one or more other, receiving (far-end) terminals 102b-d. However, it will be appreciated that in embodiments the other user terminal(s) 102b-d can also send message to be received by the first user terminal 102a and/or others in a similar manner.

The user terminal 102a comprises a user interface 202, network interface 206, and a communication client application 204 such as an IM client, video messaging client or email client. The communication client application 204 is operatively coupled to the user interface 202 and network interface 206. The user interface comprise and suitable means for enabling the sending user to compose a message and specify a definition of a destination for the message (or “channel”, i.e. any information directly or indirectly defining one or more recipient users of other terminals 102b-d). The sending user is there by able to input this information to the client application 204. For example the user interface 206 may comprise a touch-screen, or any screen plus mechanical keyboard and/or mouse. The network interface 206 provides means by which the client application can communicate with the other user terminals 12b-d and the server 103 for the purpose of sending the message to the recipient(s) and also any other of the communications disclosed herein. For example the network interface may comprise a wired or wireless interface, e.g. a mobile cellular modem, or a local wireless interface using a local wireless access technology such as a Wi-Fi network to connect to a wireless router in the home or office (which connects onwards to the Internet 108).

The server 103 comprises a messaging service 210 and a network interface 208, the messaging service being operatively coupled to the network interface 208. The messaging service 210 may for example be an IM service, video messaging service or email service. Again the network interface 208 may take the form of any suitable wired or wireless interface for enabling the messaging service 210 to communicate with the user terminals 102a-d for the purpose of communicating the users' messages and performing any others of the communications disclosed herein. Amongst various other components used to implement the messaging (as will be familiar to a person skilled in the art), the messaging service 210 also comprises a machine learning algorithm 212. Alternatively the machine learning algorithm 212 could be implemented at the sending user terminal 102a. The following will be described in terms of a server-based implementation, but it will be appreciated this is not limiting to all possible embodiments.

In operation, the sending user composes messages via the user interface 202 (so the sending user is the author), and in association with each message also uses the user interface 202 to input some information defining a respective destination of the message, i.e. its audience (where the audience can be one or more recipient users). This information may comprise an individual name (e.g. given name or username) or address (e.g. email address or network address) of a single recipient, or an individual name or address for each of multiple recipients, or an identifier of a group (e.g. of a chat session, chat room or forum). Or as another example, the information defining the destination could take the form of one or more tags specified by the sending user, e.g. where these tags indicate something about the topic of the message. In this case, the tag(s) can define a destination in that the messaging service 210 may enable other users to subscribe to a certain tag or combination of tags. Whenever a message is posted to the messaging service 210 by the sending user citing a tag or tags, then the messaging service automatically pushes the message to the users who have subscribed to that tag or combination of tags.

As mentioned, the term used herein as an umbrella term to cover all these possibilities is a “channel”. Note that in the case where the channel is a group such as chat room, the sender does not necessarily specify the individual names or addresses but rather just sends the message to the group generally based on an identifier of the group. Also, the membership of the group may change over time, and indeed the identity of the particular users in the group is not necessarily relevant in determining if an appropriate destination for the message. Similar comments apply in the case where the channel is defined in terms of one or more tags—the sender does not necessarily know or care who the particular recipients are. Hence it may be said that the channel indirectly defines the recipients, as opposed to directly in the case of individual names or addresses.

Thus the present disclosure applies to a wide array of communication systems where a user composes a message (e.g. text or document) and submits it to the communication system for delivery to other users who may then view it, providing extra information to guide the routing of the message to the receiving users. This routing information describes the list of recipients for the message, i.e. the intended audience. This general description includes (but is not limited to) the following cases:
Chat rooms. Here the routing information consists of an identifier of a chat room to which the message is to be posted. The audience are the members of the same chat room. Skype chat is a prominent example of such as a system.
Tags. Here the routing information is a set of tags assigned by the author that reflect the key concepts related to in the message. The audience consists of the users who subscribe to any of the tags. This form of communication is characteristic of blogging.

The teachings herein apply to each such form of communication, and so to describe it a common way, the concept of a collaboration channel, or channel for short, is introduced. It denotes the target audience of the message. In what follows, the user addresses the message to a number of channels. The system fans the message out to all the users who subscribe to any of these channels. A system where only one channel can be used per message boils down to a group chat system. If multiple channels are allowed, this is covered by the tag based distribution.

Based on the channel specified by the sending user, the communication client 204 uses the network interface 206 to transmit the message over the internet 108 to the user terminal(s) 102b-d of the respective one or more recipient users. In embodiments, the messages are sent via the server 103, i.e. the messaging service 210 actually receives the message from the sending user terminal 102a and forwards it on to the recipient user terminal(s) 102b-d. Each time a message is sent in this manner, the channel is recorded by the messaging service 210, along with values of a set of parameters of the message (a “feature vector”). Over time the messaging service thus builds up a large list recording the destination (channel) and parameters (feature vector) of many past messages sent by the sending user. This list is input as training data into the machine learning algorithm 212, in order to train it as to what feature vector values typically correspond to what channel (what destination), thus enabling it to make predictions as to what the destination of a future message should be given knowledge of its feature vector. Over time as further messages are sent, these are added dynamically to the training set to refine the training and therefore improve the quality of the prediction.

Preferably, when the client applications on other sending user terminals 102 send messages using the messaging service 210, the same information is also captured in a similar into the training data used to train the machine learning algorithm. Hence in embodiments, the predictions may be based on the past messages of multiple sending users on a given channel (e.g. multiple users sending messages to a given chat room or with a given tag). Alternatively, a separate model may be trained for each sending user using only information on the past messages of that user, and so the prediction may be made specifically based on the sending user's own past use of the service.

Examples will be discussed in more detail below, but to give an idea, examples of the parameters making up the feature vector include parameters based on content of the respective message, such as a title of the respective message, one or more keywords in the respective message, and/or a measure of similarity between the respective message and one or more earlier messages in the history of the channel (metrics measuring the similarity between two strings are in themselves known in the art). Other examples include: an identifier of the sending user; a time of sending the respective message (e.g. time of day, day of the week, and/or month of the year); an amount of previous activity of the sending user on the respective channel (e.g. a number or frequency of the previous messages sent by the sending user to the respective channel), and/or a relationship between the sending user and the respective one or more recipients (e.g. whether or not connected on a particular social or business network site, and/or a category of the connection or relationship).

Note: in alternative, P2P based approach the message is not sent via the server 103, but rather the messaging service 210 on the service only provides one or more supporting functions such as address look-up, storing of contact lists, and/or storing of user profiles. In such cases, whenever the communication client application 204 sends a message, it reports the channel and feature vector to the messaging service 210 to be logged in the training data set. Another possibility is that the machine learning algorithm 212 is hosted on a server of a third-party rather than the provider of the messaging service 210. In this case, either the communication client on the sending terminal 102a or the messaging service 210 may report the relevant information (channel and feature vector) to the machine learning algorithm. Or wherever the algorithm is implemented, it is even possible that the receiving terminal 102b-102d reports the information. As yet another possibility, the machine learning algorithm 212 may be implemented on the sending user terminal 102a itself

Wherever implemented, the result of the machine learning algorithm may be used in a number of ways. For instance in embodiments, the one or more potential recipients are one or more target recipients manually selected the sending user prior to sending the subsequent message. In this case, the generating of the prediction may comprise determining an estimated probability that each of the target recipients is intended by the sending user, and generating a warning to the sending user if any of the estimated probabilities is below a threshold.

Alternatively, the one or more potential recipients are one or more suggested recipients. In this case the generating of the prediction by the machine learning algorithm 212 comprises generating the suggested recipients and outputting them to the sending user prior to the sending user entering any target recipients for said subsequent message.

As another alternative, the one or more potential recipients are one or more automatically-applied recipients. In this case the generating of the prediction by the machine learning algorithm 212 comprises generating the automatically-applied recipients and sending the subsequent message to them without the sending user entering any target recipients for said subsequent message—i.e. a completely automated selection of the message destination.

Typically, users themselves determine the right channels for the message. Using the above functionality however, this adds an automated way for determining the proper channels which can be combined with the user's decision in a variety of ways, such as follows.
The system may provide information about a possible mistake before the message is processed. Here the user selects the channels, but in the background the system determines the most relevant channels as well. The system compares both sets of channels looking for sufficiently big difference. If it sees one, perhaps the user made a mistake? This situation sometimes arises in chat systems: for example, a user composes an informal message for a social chat and mistakenly posts that to a formal chat with managers and customers, just because he/she assumed the social chat was open in the chat client. This may be a source of embarrassment, confusion, or leakage of sensitive information to inappropriate audience.
The user may seeks advice from the system. It can be a case of starting from scratch; “whom should I address it to”? Or the user might have already selected some channels, but seeks hints of any other channels that might be appropriate. Either way, the user takes the advice or not, he/she is ultimately in charge of selecting the channels.
Fully automated routing. User merely composes messages and the system delivers to the audience of its own choosing.

To realize the partial or full automation of routing such a set out above, the process disclosed herein applies a framework of machine learned classification. Classification is about assigning one or more classes to each object in a collection. In embodiments of the present case, the object is the full context of the decision which includes a message, its author and the state of the channel at the time of posting, which in turn includes messages routed via the channel so far, the current channel audience/subscribers, then time of day, the activity state of the user, etc. The class is the channel that the algorithm 212 aims to assign to this context object. An alternative way of defining the problem is in terms of binary classification, where the object being classified is the full context of the posting together with the channel, and the binary decision is “post” versus “do not post” (or “send” versus “do not send”).

More specifically, a probabilistic approach is used, where the classification produces an estimate of a probability of such a channel assignment. It is a measure of confidence that one ought to assign the message to that channel, given all the context information.

If given a new message, the system provides the list of probabilities for every eligible channel (a candidate), then it is possible to use that information to realize the functionality listed above. For a mistake alert, the algorithm 212 would compare the probability of the selected channel against the maximum probability across all channels. If the difference is sufficiently big, it has grounds for suspecting a mistake, and can alert the user (via the client 204) before the message is submitted. Moreover it can also indicate the channel that he/she might have meant. For the suggestion use case, the algorithm 212 can select one or a few channels having the top probability (in embodiments subject to some minimum threshold).

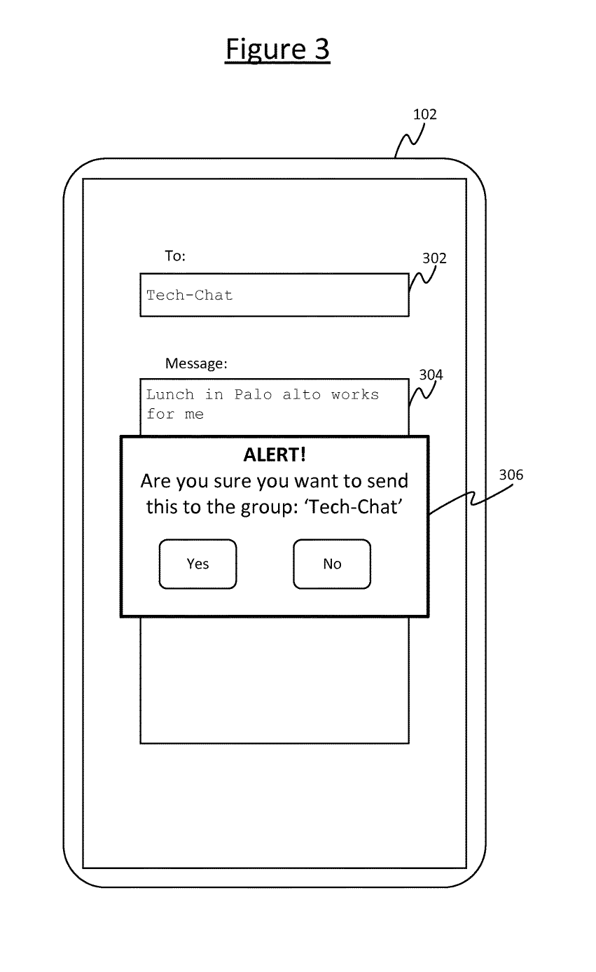

An illustrative example is described in relation to FIG. 3. Consider user X who is a member of two chat rooms: technical one and social one. The recent history of the chats may be as follows:

### Technical Chat Room:

Y: What are your results using boosted decision trees?
X: Not sure, we only tried SVM and logistic regression.
Y: I wonder how boosted trees perform.

### Social Chat Room:

X: hey guys, who wants to grab lunch outside tomorrow?
Y: we can maybe go to Palo Alto downtown, Mountain View or Los Altos?
Y: which one do you prefer?

Consider user X composing a message “Lunch in Palo Alto works for me”. Suppose in the rush of the work day, the technical chat is currently open on user X's chat application, and the user ends up posting the lunch negotiation message there, by mistake.

If the user was aided by a dedicated and alert human assistant, one can expect the assistant to realize that the message does not really belong to the technical chat, but rather to the social one. Intuitively, we can expect an automated system to realize the mistake as well, at least in some instances, for example by comparing keywords (e.g. “Lunch” and/or “Palo Alto” is mentioned in the social chat and not the technical one, at least recently).

This is illustrated in FIG. 3. The client application 204, through the user interface 202 on the sending user terminal 102a, displays a first field 302 in which the sending user inputs a channel (in the case the name of a chat room), and a second field 304 where the sending user inputs the message itself (the message content). In the first field 302 the sending user has input a response to the lunch conversation intended for the social chat room, but in the second field 304 the specified destination is the technology chat room. In response to detecting that this seems unlikely to be an intended combination, the algorithm 212 sends an alert signal to the communication client 204, in response to which the client outputs an on-screen warning 306 through the user interface 202. The warning 306 gives the sending user the option to either prevent or go ahead with the sending.

In the following are described further details for computing classification probabilities required for our invention using machine learning. The following examples will employ a binary classification method.

In machine learning classification, there are two key components that define its application to a specific domain:
Definition of features containing sufficient predictive power with respect to the classification task
Definition of a way to assemble large training set of labeled examples, i.e. the “ground truth”.

Both approaches are discussed below and in embodiments both are used to implement the machine learning algorithm 212.

The training involves three aspects: individual training examples, a training set and a learning model. A training example, in the sense of binary classification, may be defined as a tuple of message M, author A, and the state of channel C at the time of posting the message. By state of the channel is understand the combination of all messages that were posted to this channel before and its current audience. If this given message M was actually posted to channel C, it constitutes a positive example (labeled as true), otherwise it constitutes a negative example (labeled as false). For each example a number of features are defined, in a standard machine learning sense. These are numbers that convey comprehensive information about the example.

The training set is based on all the prior messages recorded in the communication system (preferably all the past messages of multiple users, not just those of the particular sending user for whom a prediction is currently being made). For a given message M, it go through all the channels C where M was actually posted to. A positive example is defined for each such C, containing the message M, its author A and the state of C at the time of posting, this example is labelled as true. Thus a feature vector is derived for every one of the labelled examples. In embodiments, for all the remaining channels C′, where the message M was not posted, a negative example may be defined for each of them, containing the message M, it's author A and the state of channel C′ at the time of posting, labeled as false. That is, the training data set may also include false examples, wherein each of the false examples comprises, for a respective one of the past messages, an example of a channel to which that message was not sent. These may for example be generated randomly. I.e. for any given message M that was sent to channel(s) C, some other channels C′ is selected randomly from the set of all observed channels, where the message was not sent. This then constitutes a negative example (labelled as “false”).

Regarding the learning a model, the list of feature vectors with the binary labels is fed into to any standard machine learning algorithm for binary classification. There is a number of choices including logistic regression, boosted decision trees and support vector machines. The output is a model which provides a prediction function that can take any new message M, its author A and any candidate channel C (in a state at the time of posting the message M) and produce an estimate of the probability of M belonging to C. The choice of particular machine learning algorithm for binary classification is not essential, and a number of different machine learning algorithms are in themselves known in the art.

Some more details of the features that may be used in the model are now discussed. In embodiments a training example, whether positive or negative, contains a number of elements, roughly structured as follows:
text of the message
author
state of the channel at the time of posting, which in turns breaks into:
   history of messages posted there so far (including text, timestamp and other metadata of each message)
   audience (other users who would read the message if it was posted into that channel),
time of posting

This provides a wealth of information of mostly qualitative nature that may yield a variety of patterns. The following features attempt to describe the information in a quantitative manner.

A first category of features that may be included in the feature vector according to embodiments of the present disclosure are features relating the message to channel history.

One motivation for this was shown in the illustrative example above. This shows a situation where a user may be writing a reply to someone else's message in chat (channel) X, but by mistake addressing it to chat (channel) Y. Chances are that the message shares terms (words) with the message (or a couple of messages constituting the temporary focus of discussion) in chat X. Moreover, there may be several topics discussed in channel X, at earlier times, not only at the latest moment.

These features are about text similarity between the message (treated as a text document) and the history of messages posted to the channel (treated as another, bigger document, by concatenating all the messages it was assigned to). If the message document and the channel history document are represented as a bag of words (the skilled person will be familiar with the “bag of words” model) then one can use a number of well know methods for deriving the quantitative similarity between the two, for example:
Cosine similarity,
tf-idf similarity,
Latent Semantic Indexing (LSI), or
A distributed representation such as Deep Structured Semantic Models (DSSM) or word2vec.

These methods differ in complexity. Cosine similarity and tf-idf are the simplest and semantic methods (such as LSI, DSSM) are complex, with implications on resulting efficiency of computation and ease of implementation. Semantic methods strive to unlock semantic features in the text, for example by recognizing equivalence of synonyms that would be otherwise considered as not matching. There are many pros and cons for the choice of the text similarity method, which are generally known and widely studied. However, the choice of particular text similarity algorithm is not material.

Whatever similarity metric is chosen, the parameters (features) of the feature vector may thus comprise a measure of similarity between the respective message and a concatenation of the earlier messages in the channel history within a predetermined time window prior to the respective message (preferably including the earlier messages of all users recorded as having sent to the channel in that time window). E.g. one of the elements of the feature vector may comprise a cosine similarity (or such like) between the body of the respective message and a concatenation of the earlier messages in the history from the preceding hour, or preceding day, or such like.

Further features of the feature vector may comprise temporal aspects. If the full message history was to be used to measure the similarity, the temporal effects of communication would not have been represented fully. For example, in chat communication people typically send messages addressing other recent messages sent by other users. Occasionally they also address older messages, especially when there are several topics being discussed concurrently in the chat. Moreover, certain terms may be characteristic of the overall chat purpose, and they can be scattered arbitrarily in the history of the chat.

Therefore in embodiments the text similarity feature is split into several features defined by the similarity of the message to fragments of the history spread across time. This can be done in variety of ways, for example as follows.
Contiguous samples of the history from the latest message back in time, until certain number of messages or certain amount of time. For example: last message, last 10 messages, last 100 messages etc. Or: last hour, last day, last month of message history, etc.
Contiguous samples of the history with both start and end moving back in time. For example, last 10 messages, messages from 11th to 20th, messages from 20th to 30th, etc. Or: last day worth of messages, a day before that, another day before that, etc.

These ways can also be combined, defined by variety of intervals (time windows) to sample with. It may not be known a priori which fragments of history are more important than others, therefore in embodiments many of them are included in the feature vector.

Thus, the parameters (features) of the feature vector may comprise a set of different instances of the measure of similarity, each being a measure of similarity between the respective message and a concatenation of the earlier messages in the training data set sent to the respective channel within a different time window prior to the respective message.

Another category of features that may be included in the feature vector according to embodiments of the present disclosure are features describing the sending user's history in the channel.

One motivation for this is to try to capture the patterns of user's behaviour with respect to his/her own prior communication in a given channel, such as its intensity and/or vocabulary. For instance these may include one or both of the following.
Count of messages—how many messages the author already posted to the channel. This may be normalized by dividing by all user's messages across all channels.
One or more features relating the respective message to the history of the sending user's prior posts to the channel. Here, the same approach may be used as for the features relating the message to the history of all messages as described above, but applied specifically on a per user basis (only to messages sent by a particular sending user). I.e., a text similarity may be measured between the message and fragments of the particular user's history on the channel spread across time.

Another category of features that may be included in the feature vector according to embodiments of the present disclosure are features describing the audience of the channel.

One motivation for this is to capture the patterns of the sending user's differentiated behaviour (in terms of what and how he communicates) depending on the audience, its size and composition. For example, one typically is reserved when addressing a manager, or his manager, while being relaxed and causal when addressing buddies in a social context. Examples of such features include the following.
Size of the audience (number of users that can read the message at the time of posting)
Average number of posts per day
In a team or enterprise setting, if organizational information is available, features may be included that relate the author to the audience with respect to the organization structure. The specific examples of such features are:
   The fraction of author's team members that are in the channel audience
   The fraction of author's management chain in the audience
   The mean and variance of the organizational depth and organizational depth difference of the audience members.

Yet another category of features that may be included in the feature vector according to embodiments of the present disclosure are features describing time of posting (time of sending).

A motivation for this is to try to capture the patterns of user's behaviour at different times of the day, week, month and/or year. For example, the following Boolean valued features may apply in an enterprise setting:
Is the message posted during working hours?
Is the message posted late at night?
Is the message posted on a week day?

In embodiments, additional metadata available in the channel may be leveraged. Specific communication systems may employ additional metadata associated with the channel. For example, a chat room may be assigned a title, or some keywords or categories, selected by the room owner, to reflect the focus and interest of the discussion in that chat room. These additional elements can be rolled into the present method, by defining additional features. For example, the owner assigned title or keywords of the channel and yield a feature of text between the title words (or keywords) and the text of new message.

A further optional addition to the above techniques is to improve the accuracy of the model with the help of human editors. So far the disclosure has described a fully automated system that learns and predicts without human intervention. This can be extended by adding higher quality training sets produced by human editors. In this arrangement one may envision that a new message (generated by another human user, or perhaps generated by the system) is presented to the editor without any hint of the channel(s) selected for this message. The task of the editor would be to classify this message by hand, and pick the most appropriate channel(s). This procedure will not only produce a high quality training set, but can also serve to test the predictions of the model.

In addition, the fully automated arrangement assumes there is already enough data in the system to produce the training set. Human editor arrangement may address a green field scenario where the system without any history.

It will be appreciated that the above embodiments have been described only by way of example.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof In the case of a software implementation, the module, functionality, or logic represents program code that performs specified tasks when executed on a processor (e.g. CPU or CPUs). The program code can be stored in one or more computer readable memory devices. The features of the techniques described below are platform-independent, meaning that the techniques may be implemented on a variety of commercial computing platforms having a variety of processors.

For example, the user terminals and/or server may also include an entity (e.g. software) that causes hardware of the user terminals to perform operations, e.g., processors functional blocks, and so on. For example, the user terminals and/or server may include a computer-readable medium that may be configured to maintain instructions that cause the user terminals, and more particularly the operating system and associated hardware of the user terminals to perform operations. Thus, the instructions function to configure the operating system and associated hardware to perform the operations and in this way result in transformation of the operating system and associated hardware to perform functions. The instructions may be provided by the computer-readable medium to the user terminals and/or server through a variety of different configurations.

One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may us magnetic, optical, and other techniques to store instructions and other data.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
collecting a training data set describing multiple past messages previously sent over a computer-implemented communication service, wherein for each respective one of the past messages, the training data set comprises a record of a respective channel of the respective message, and a record of a respective feature vector of the respective message, wherein the channel corresponds to a respective one or more recipients to which the respective message was sent, and wherein the feature vector comprises a respective set of values of a plurality of parameters associated with the sending of the respective message;
inputting the training data into a machine learning algorithm in order to train the machine learning algorithm; and
by applying the machine learning algorithm to a further feature vector comprising a respective set of values of said parameters for a respective subsequent message, to be sent by a sending user over the computer-implemented communication service, generating a prediction regarding one or more potential recipients of the subsequent message.

2. The method of claim 1, wherein the one or more potential recipients are one or more target recipients manually selected the sending user prior to sending the subsequent message, and wherein the generating of said prediction comprises determining an estimated probability that each of the target recipients is intended by the sending user, and generating a warning to the sending user if any of the estimated probabilities is below a threshold.

3. The method of claim 1, wherein the one or more potential recipients are one or more suggested recipients, the generating of said prediction comprising generating the suggested recipients and outputting them to the sending user prior to the sending user entering any target recipients for said subsequent message.

4. The method of claim 1, wherein the one or more potential recipients are one or more automatically-applied recipients, the generating of said prediction comprises generating the automatically-applied recipients and sending the subsequent message to them without the sending user entering any target recipients for said subsequent message.

5. The method of claim 1, wherein each of the channels comprises an individual name or address of a single recipient, or an individual name or address of each of multiple recipients.

6. The method of claim 1, wherein each of the channels comprises an identifier of group of a plurality respective recipients.

7. The method of claim 1, wherein the group is a chat room or forum.

8. The method of claim 1, wherein each of the channels comprises one or more tags, to which the respective one or more recipient users subscribe.

9. The method of claim 1, wherein the parameters of each of the feature vectors comprise one or more parameters based on content of the respective message.

10. The method of claim 9, wherein the one or more parameters based on the content comprise any one or more of:
a title of the respective message,
one or more keywords in the respective message,
a measure of similarity between the respective message and one or more earlier messages in the training data set sent to the respective channel, and/or
a measure of similarity between the respective message and one or more earlier messages in the training data set sent to the respective channel by the sending user.

11. The method of claim 10, wherein the one or more parameters based on the content comprise: a measure of similarity between the respective message and a concatenation of the earlier messages sent to the respective channel within a predetermined time window prior to the respective message.

12. The method of claim 11, wherein the one or more parameters based on the content comprise: a set of different instances of the measure of similarity, each being a measure of similarity between the respective message a concatenation of the earlier messages sent to the respective channel within a different time window prior to the respective message.

13. The method of claim 1, wherein the parameters of each of the feature vectors further comprise any one or more of:
an identifier of the sending user,
a time of sending the respective message,
an amount of previous activity of the sending user on the respective channel, and/or
a relationship between the sending user and the respective one or more recipients.

14. The method of claim 1, wherein the training data set further includes false examples, each of the false examples comprising, for a respective one of the past messages, an example of a channel to which the respective message was not sent.

15. The method of claim 1, wherein the communication service comprises an IM chat messaging service, video messaging service and/or, and each of the messages in the training data set comprises an IM chat message, video message or email respectively.

16. The method of claim 1, wherein the training data set is refined by a human editor.

17. A network element comprising:
a data store storing a training data set describing multiple past messages previously sent over a computer-implemented communication service, wherein for each respective one of the past messages, the training data set comprises a record of a respective channel of the respective message, and a record of respective feature vector of the respective message, wherein the channel corresponds to a respective one or more recipients to which the respective message was sent, and wherein the feature vector comprises a respective set of values of a plurality of parameters associated with the sending of the respective message; and
a machine learning algorithm arranged to be trained based on the training data set;
wherein based on a further feature vector comprising a respective set of values of said parameters for a respective subsequent message, to be sent by a sending user over the computer-implemented communication service, the machine learning algorithm is arranged to generate a prediction regarding one or more potential recipients of the subsequent message;
wherein the parameters of each of the feature vectors comprise one or more parameters based on content of the respective message.

18. The network element of claim 17, wherein the network element is a server arranged to serve a user terminal of the sending user.

19. The network element of claim 17, wherein the network element is a user terminal of the sending user.

20. A computer program product embodied on a computer-readable storage medium and configured so as when run on a processing apparatus comprising one or more processing units to perform operations of:
accessing a training data set describing multiple past messages previously sent over a computer-implemented communication service, wherein for each respective one of the past messages, the training data set comprises a record of a respective channel of the respective message, and a record of respective feature vector of the respective message, wherein the channel corresponds to a respective one or more recipients to which the respective message was sent, and wherein the feature vector comprises a respective set of values of a plurality of parameters associated with the sending of the respective message;
inputting the training data into a machine learning algorithm in order to train the machine learning algorithm; and
by applying the machine learning algorithm to a further feature vector comprising a respective set of values of the parameters of a respective subsequent message, to be sent by a sending user over the computer-implemented communication service, generating a prediction regarding one or more potential recipients of the subsequent message;
wherein the parameters of each of the feature vectors comprise one or more parameters based on content of the respective message.
